(19) United States
(12) Patent Application Publication
(10) Pub. No.: US 2002/0033356 A1
(43) Pub. Date: Mar. 21, 2002

(54) Desalter control system

(75) Inventors: Tatsuho Honda, Tokyo (JP); Hiroshi Kurumato, Tokyo (JP)

Correspondence Address: STAAS & HALSEY LLP, 700 11TH STREET, NW, SUITE 500, WASHINGTON, DC, 20001, US

(73) Assignee: Tatsuho HONDA, Tokyo (JP)

(21) Appl. No.: 09/927,511

(22) Filed: Aug. 13, 2001

(30) Foreign Application Priority Data
Aug. 25, 2000 (JP) 254978/2000

(51) Int. Cl. C10G 19/00; B01D 17/04

(52) U.S. Cl. 208/251 R; 208/187; 208/188; 210/708

(57) ABSTRACT

A system is provided which is capable of measuring the thickness of an emulsion layer in a desalter, with high precision and in real time.

In the desalter for introducing crude oil with which an emulsion breaker and water are mixed, forming the emulsion layer, separating a mixture of oil and water to form the upper and lower regions of a vessel across the emulsion layer, separating and dissolving chloride ion contents in the crude oil into the water, draining the desalted oil from the topside of the vessel, and draining the separated water from the bottom side of the vessel, the thickness of the emulsion layer is measured according to the distribution of pressure difference between an internal solution, including the emulsion layer, ranging from the top to bottom sides of the vessel and the drained water.

### BACKGROUND OF THE INVENTION

1. Field of the Invention

The present invention relates to a system for controlling a desalter installed in a stage preceding a crude unit (crude oil atmospheric distillation process unit) to which crude oil is introduced in an oil refining process.

2. Description of the Prior Art

A desalter installed in a stage preceding a crude oil atmospheric distillation process unit in an oil refining plant is intended to remove chloride ion contents in crude oil that can cause corrosion in a distillation tower. In order to ensure continuous long-term operation of the plant, it is important that the desalting capability of the desalter is fully achieved. At present, however, conventional desalters are still manually operated and controlled.

FIG. 1 is a diagrammatic view showing one example of a prior art desalter control system. Crude oil Pi from a raw material tank 1 is introduced by a pump 3 through an input pipeline 2 to a region between emulsion-breaking electrodes 5a and 5b within the vessel 4 of a desalter. Note here that the process of producing emulsion is excluded from the explanation of the prior art.

Numerals 6 and 7 denote heat exchangers installed at given points along the input pipeline 2. A numeral 8 denotes an emulsion breaker storage tank. A given amount of emulsion breaker E is injected into the crude oil Pi of the input pipeline 2 through a pipeline 10, in a stage preceding the heat exchangers 6 and 7, by means of a pump 9 whose flow rate is defined by a setpoint S1.

A numeral 11 indicates a water-inlet pipeline for mixing water W with the crude oil Pi of the input pipeline 2 in a stage following the heat exchangers 6 and 7. A numeral 12 denotes flow rate control means for adjusting the flow rate of injected water to a setpoint S2.

A numeral 13 denotes a differential pressure control valve installed in a stage immediately following the point of water injection. The opening of the valve is controlled by means of a setpoint S3, and the degree of mixing water with the crude oil is controlled according to the difference between pressures before and after the valve.

A region 14 shaded with oblique lines is an emulsion layer formed within the vessel 4 of the desalter. The layer has a given thickness of t. With the emulsion layer serving as the boundary, a mixture of crude oil and water separates into water in which salt is dissolved to settle in the lower region of the vessel, and into desalted oil to settle in the upper region thereof.

A numeral 15 denotes an output pipeline for introducing the desalted crude oil Po from the topside of the vessel 4 to the atmospheric distillation process unit. A numeral 16 denotes a drainage pipeline for draining water W′, wherein salt is dissolved, from the bottom side of the vessel 4. A numeral 17 denotes a control valve for manipulating the flow rate of drainage.

A numeral 18 denotes an interface level sensor whose sensing unit is installed so as to vertically penetrate through the emulsion layer 14. The center (depth L as measured from the bottommost side of the vessel 4) of the emulsion layer 14 indicated by a dashed line 19 is controlled to a given depth within the vessel 4, by means of a controller 20 to which the process variable and setpoint S4 of the interface level sensor 18 are input, in order to manipulate the control valve 17 for controlling the flow rate of drainage.

In the case of a desalter configured in such a manner as described above, the rate of desalting largely depends on the thickness t of the emulsion layer 14. The main point of desalter operation, therefore, is that the amounts of emulsion breaker, injected water, and water mixed with the crude oil be manually controlled so that the thickness t of the emulsion layer 14 is maintained at an optimum value.

In order to verify the thickness t of the emulsion layer 14, a method is employed for vertically sampling a solution at a plurality of points within the vessel 4 across the emulsion layer 14. Numerals 21a to 21e denote a plurality of parallel sampling pipelines arranged vertically within the vessel 4 of the desalter across the emulsion layer 14. Numerals 22a to 22e denote valves installed on these sampling pipelines.

The operator successively manipulates these valves at fixed time intervals or as necessary, in order to take a plurality of samples into a container 23 made available for each sample. Then, the thickness t of the emulsion layer 14 is predicted from the transmittance and other conditions of each sample examined by laboratory analysis and visual inspection.

Thus, the task of measuring such an important control variable as the thickness t of the emulsion layer 14 is dependent on manual sampling by the operator and laboratory analysis. For this reason, manipulation is delayed when the thickness t changes. This delay causes reduced desalting efficiency and mixing of oil into wastewater.

Furthermore, the amounts of emulsion breaker, injected water, and water mixed with the crude oil are manually manipulated, in order to maintain the thickness t of the emulsion layer 14 at an optimum value. It is extremely difficult, however, for even an experienced operator to optimally control the thickness t that is influenced by a plurality of parameters in a complex manner.

The measurement resolution of the thickness t is determined by the spacing interval of sampling pipelines. Accordingly, measurement accuracy is limited if there is any limit on the number of sampling pipelines. It is therefore difficult to maintain the thickness t with high precision.

### SUMMARY OF THE INVENTION

In order to solve the above-noted problems, the present invention as described in claim 1 provides a control system for a desalter for introducing crude oil with which an emulsion breaker and water are mixed, forming an emulsion layer, separating a mixture of oil and water to form the upper and lower regions of a vessel across the emulsion layer, separating and dissolving chloride ion contents in the crude oil into the water, draining the desalted oil from the topside of the vessel, and draining the separated water from the bottom side of the vessel, wherein the thickness of the emulsion layer is measured according to the distribution of the pressure difference between an internal solution, including the emulsion layer, ranging from the top to bottom sides of the vessel and the water in the lower region of the vessel.

According to claim 2 of the present invention, a control system is provided for a desalter for introducing crude oil with which an emulsion breaker and water are mixed, forming an emulsion layer, separating a mixture of oil and water to form the upper and lower regions of a vessel across the emulsion layer, separating and dissolving chloride ion contents in the crude oil into the water, draining the desalted oil from the topside of the vessel, and draining the separated water from the bottom side of the vessel, wherein the thickness of the emulsion layer is measured according to the density distribution of an internal solution, including the emulsion layer, ranging from the top to bottom sides of the vessel.

According to claim 3 of the present invention, the above-described desalter control system comprises means for sampling the internal solution, including the emulsion layer, ranging from the top to bottom sides of the vessel in a periodic and sequential manner, wherein sampled solutions are introduced to a single differential pressure sensor or density sensor so that the thickness of the emulsion layer is periodically measured.

According to claim 4 of the present invention, the amounts of emulsion breaker, injected water, and water mixed with the crude oil are manipulated according to control model formulas based on information on the measured thickness of the emulsion layer, the pH value of the drained water, and a set of parameters including the specific gravity of the crude oil, so that the thickness of the emulsion layer is controlled to an optimum value.

According to claim 5 of the present invention, the set of parameters in the control model formulas is tuned according to the type of oil and operating conditions.

### BRIEF DESCRIPTION OF THE DRAWINGS

FIG. 1 is a diagrammatic view showing one example of a conventional desalter control system.

FIG. 2 is a diagrammatic view showing one embodiment of the desalter control system according to the present invention.

FIG. 3 is a graph showing the differential pressure measurement pattern of sampled solutions according to the present invention.

FIG. 4 is a schematic view explaining a procedure for calculating the thickness of an emulsion layer based on the differential pressure measurement of sampled solutions according to the present invention.

FIG. 5 is a schematic view showing the main parts related to the measurement of the specific gravity of sampled solutions.

FIG. 6 is a graph showing the specific gravity measurement pattern of sampled solutions according to the present invention.

### DETAILED DESCRIPTION OF THE PREFERRED EMBODIMENTS

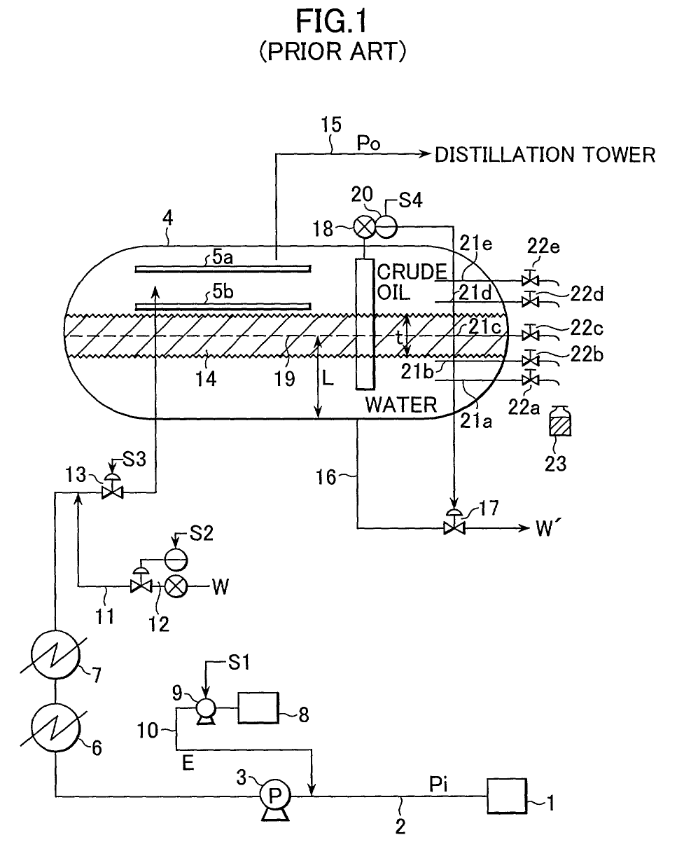

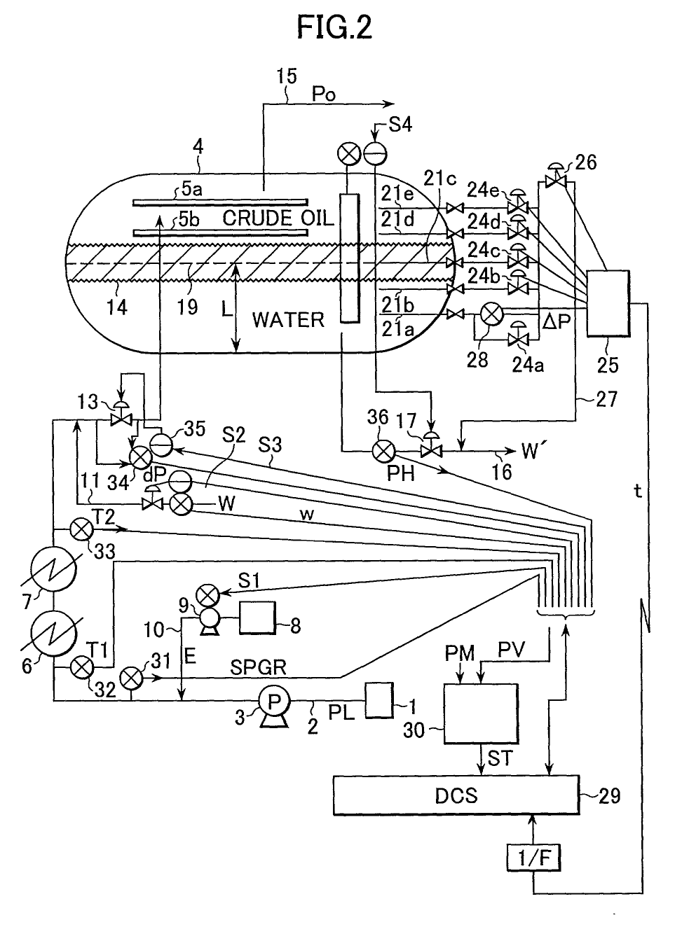

Embodiments of the present invention will now be described in detail with reference to the accompanying drawings. FIG. 2 is a diagrammatic view showing one embodiment of the desalter control system according to the present invention. Components identical to those of the prior art system shown in FIG. 1 are referenced alike and excluded from the following explanation. Thus, only the characteristic features are hereafter described.

Symbols 24a to 24e denote valves for sampling a solution introduced through sampling pipelines 21a to 21e, and the valves are opened/closed sequentially and periodically by means of a signal from a local unit 25. The output sides of these sampling valves are connected to the same common line. Sampled solutions are guided through a valve 26 which is opened or closed by means of a signal from the local unit 25, and through a drainage pipeline 27, then merged with wastewater W′ from a drainage pipeline 16, and finally drained.

A numeral 28 denotes a differential pressure sensor for measuring a pressure difference ΔP between the input of a sampling valve 24a for introducing a solution in the bottommost sampling pipeline 21a of the vessel 4 of a desalter and the commonly connected output of each sampling valve. Thus, the differential pressure sensor transmits the result of measurement to the local unit 25.

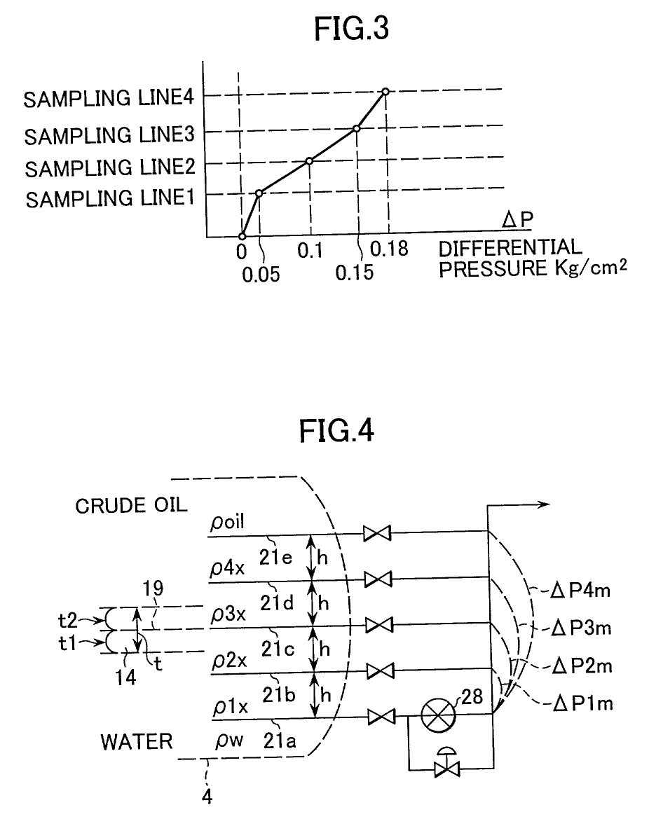

In such a sampling system configuration as described above, the differential pressure ΔP of a solution from each sampling pipeline is successively measured on the basis (zero differential pressure) of the solution (water) in the bottommost pipeline 21a of the vessel 4 of the desalter, and introduced to the local unit 25. FIG. 3 is a graph obtained by plotting the variation in the differential pressure ΔP appropriate for each sampling line.

FIG. 4 is a schematic view explaining the procedure for calculating the thickness t of the emulsion layer from a differential pressure signal. Symbols in the figure are defined as:

ρw=Specific gravity of solution (water) in the lower region of the vessel 4 of desalter

ρoil=Specific gravity of solution (crude oil) in the upper region of the vessel 4 of desalter

ρe=Specific gravity of emulsion layer 14

ρ1x=Specific gravity of solution between sampling pipelines 21a and 21b

ρ2x=Specific gravity of solution between sampling pipelines 21b and 21c

ρ3x=Specific gravity of solution between sampling pipelines 21c and 21d

ρ4x=Specific gravity of solution between sampling pipelines 21d and 21e

ΔP1m=Difference in pressure of solution between sampling pipelines 21a and 21b

ΔP2m=Difference in pressure of solution between sampling pipelines 21b and 21c

ΔP3m=Difference in pressure of solution between sampling pipelines 21c and 21d

ΔP4m=Difference in pressure of solution between sampling pipelines 21d and 21e

h=Equal spacing interval between sampling pipelines

In addition, t1 and t2 are defined as

t1=Thickness from the center to the bottom of emulsion layer

t2=Thickness from the center to the top of emulsion layer

in the case of level/depth control based on an interface level sensor where the center 19 of the emulsion layer 14 is controlled to a position near the position of the middle sampling pipeline 21c. Consequently, t=t1+t2.

The specific gravity of each layer therefore can be calculated as

ρ1x=ρw−(ΔP1m)/h

ρ2x=ρw−(ΔP2m−ΔP1m)/h

ρ3x=ρw−(ΔP3m−ΔP2m)/h

ρ4x=ρw−(ΔP4m−ΔP3m)/h

The thickness t of the emulsion layer can also be calculated by approximation using specific gravities ρ2x and ρ3x. Assuming the specific gravity of the emulsion layer lies between those of crude oil and water and expressed as ρe, then the thickness t is calculated as shown below in the case of FIG. 4 where ρ1x and ρ4x are defined by approximation as ρ1x=ρw and ρ4x=ρoil.

t1=h×(ρw−ρ2x)/(ρw−ρe)×α1

t2=h×(ρw−ρ3x)/(ρoil−ρe)×α2

t=t1+t2

where α1 and α2 are tuning factors.

Referring back to FIG. 2, the characteristic features of the present invention will be described further. A measurement signal for the thickness t of the emulsion layer calculated within the local unit 25 is fed through an interface to a distributed control system (hereinafter abbreviated as DCS) 29. A numeral 30 denotes a control model computation unit to which a parameter PM including information on the type of oil and the process variables PV of various sensors are input. The control model computation unit 30 feeds the control target setpoint ST of each final control element to the DCS 29 for optimizing the thickness t. The DCS 29, receiving inputs of the measurement signal for the thickness t, the process variables PV of various sensors, and control target setpoints ST, executes necessary control computations to control the final control elements.

A numeral 31 denotes a specific gravity sensor for the crude oil Pi, and a symbol SPGR denotes the measured specific gravity value of the specific gravity sensor 31. A symbol E denotes the amount of emulsion breaker supplied by a pump 9 operated by means of a setpoint s1 from the DCS 29. A numeral 32 denotes a crude oil temperature sensor on the inlet side of heat exchangers and a symbol T1 denotes a value of temperature measured by the sensor 32. A numeral 33 denotes a crude oil temperature sensor on the outlet side of the heat exchangers and a symbol T2 denotes a value of temperature measured by the sensor 33.

A symbol w denotes the measured flow rate of means 12 for controlling mixed water W that receives a setpoint s2 from the DCS 29.

A numeral 34 denotes a differential pressure sensor, and a symbol dp denotes a measured pressure difference between the inlet and outlet of a differential pressure control valve 13. A numeral 35 denotes a controller for manipulating the opening of the differential pressure control valve 13, wherein the opening is controlled by means of a setpoint s3 from the DCS 29.

A numeral 36 denotes a pH sensor installed on a drainage pipeline 16, and a symbol pH is a pH value measured by the pH sensor 36.

The thickness t of the emulsion layer is correlated with each process variable, including the type of oil. This correlation is expressed in general as

t=a0+a1×SPGR+a2×T1+a3×T2+a4×pH+a5×E+a6×w 30 a7×dp

where

t=Thickness of emulsion layer

SPGR=Specific gravity of crude oil

T1=Inlet temperature of heat exchanger

T2=Outlet temperature of heat exchanger

pH=pH value of wastewater W′

E=Amount of injected emulsion breaker

w=Amount of mixed water

dp=Differential pressure (pressure difference between the inlet and outlet of differential pressure control valve 13)

a0 to a7=Constant parameters

The control model computation unit 30 calculates optimum constant parameters by simulational computing, according to such correlation. The unit also feeds optimum manipulated variables to final control elements for manipulating the amount of emulsion breaker, the amount of mixed water, and the value of differential pressure. With this automatic control loop, it becomes possible to completely automate desalters that have been operated manually in the prior art system.

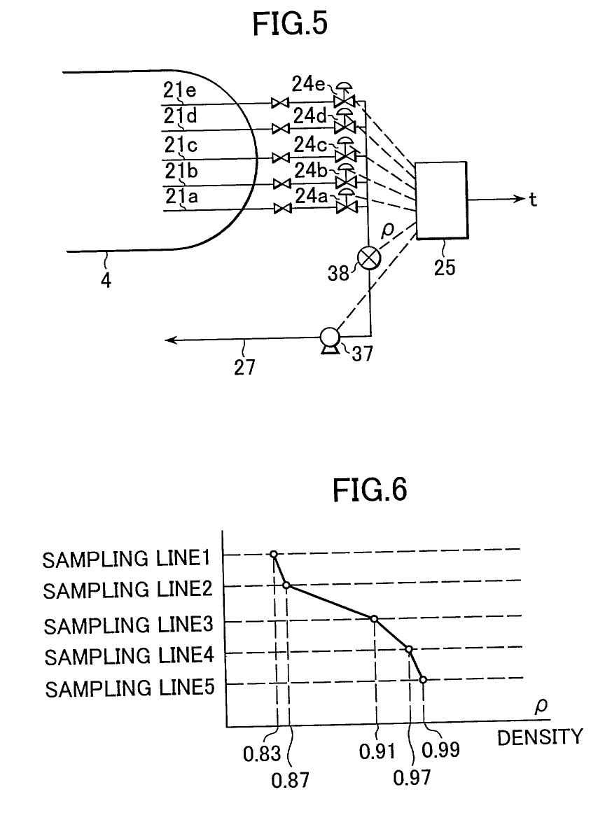

FIG. 5 is a schematic view showing the main parts of another embodiment of the desalter control system according to the present invention, wherein the main parts are related to the calculation of the thickness t of an emulsion layer. This embodiment is characteristic in that the specific gravity ρ of the sampled solution of each layer is directly measured. A numeral 37 denotes a sampling pump installed at a given point along the drainage pipeline 27 for draining sampled solutions. A numeral 38 denotes a specific gravity sensor also installed at a given point along the drainage pipeline 27.

FIG. 6 is a graph of the specific gravity distribution within the vessel 4 of the desalter, including the emulsion layer, obtained by measuring sampled solutions as described above.

As is evident from the description provided heretofore, the following advantageous effects are expected from the present invention:

1) The thickness of an emulsion layer can be measured with much higher precision, compared with the accuracy of conventional laboratory analysis, according to calculations based on the measured differential pressure or density of sampled solutions.

2) The thickness of an emulsion layer can be measured almost in real time, thereby solving the problem of delay in control.

3) Manipulation of the amounts of emulsion breaker, injected water, and mixed water can be automatically controlled by a DCS using control models. Thus, the thickness t of an emulsion layer under the complicated influence of a plurality of parameters can be optimally controlled without the need for an experienced operator.

The implementation of such an optimum control system for desalters as described above makes it possible to dramatically improve the corrosive environment of plants. As a result, it is possible to extend the service life of plant facilities and equipment and realize an environment for maintenance-free, long-term continuous plant operation. Thus, these advantageous effects are expected to have great economic advantages and ensure safe plant operation.

Another advantageous effect resulting from the realization of the optimum control system is that it is possible to optimally control the amount of anticorrosive agent injected at an atmospheric distillation process unit in a later stage of the process. The system thus helps save the amount of anticorrosive agent and provides favorable economic effects in plant operation.

What is claimed is:

1. A desalter control system for a desalter for introducing crude oil with which an emulsion breaker and water are mixed, forming an emulsion layer, separating a mixture of oil and water to form the upper and lower regions of a vessel across said emulsion layer, separating and dissolving chloride ion contents in said crude oil into said water, draining said desalted oil from the topside of said vessel, and draining said separated water from the bottom side of said vessel, wherein the thickness of said emulsion layer is measured according to the distribution of the pressure difference between an internal solution, including said emulsion layer, ranging from the top to bottom sides of said vessel and said water in the lower region of said vessel.

2. A desalter control system for a desalter for introducing crude oil with which an emulsion breaker and water are mixed, forming an emulsion layer, separating a mixture of oil and water to form the upper and lower regions of a vessel across said emulsion layer, separating and dissolving chloride ion contents in said crude oil into said water, draining said desalted oil from the topside of said vessel, and draining said separated water from the bottom side of said vessel, wherein the thickness of said emulsion layer is measured according to the density distribution of an internal solution, including said emulsion layer, ranging from the top to bottom sides of said vessel.

3. The desalter control system of claim 1 or 2, comprising means for sampling said internal solution, including said emulsion layer, ranging from the top to bottom sides of said vessel in a periodic and sequential manner, wherein sampled solutions are introduced to a single differential pressure sensor or density sensor so that the thickness of said emulsion layer is periodically measured.

4. The desalter control system of claim 1, 2 or 3, wherein the amount of said emulsion breaker, the amount of injected water, and the degree of mixing water with said crude oil are manipulated according to control model formulas based on information on the measured thickness of said emulsion layer, the pH value of said drained water, and a set of parameters including the specific gravity of said crude oil, so that the thickness of said emulsion layer is controlled to an optimum value.

5. The desalter control system of claim 4, wherein said set of parameters in said control model formulas is tuned according to the type of oil and operating conditions.
